(19) United States
(12) Patent Application Publication
(10) Pub. No.: US 2003/0195939 A1
(43) Pub. Date: Oct. 16, 2003

(54) Conditional read and invalidate for use in coherent multiprocessor systems

(76) Inventors: Samatha J. Edirisooriya, Tempe, AZ (US); Sujat Jamil, Chandler, AZ (US); David E. Miner, Chandler, AZ (US); R. Frank O'Bleness, Tempe, AZ (US); Steven J. Tu, Phoenix, AZ (US); Hang T. Nguyen, Tempe, AZ (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/123,401

(22) Filed: Apr. 16, 2002

(51) Int. Cl. G06F 15/167; G06F 15/16; G06F 13/28

(52) U.S. Cl. 709/212; 709/253; 711/118

(57) ABSTRACT

A conditional read and invalidate operation for use in coherent multiprocessor systems is disclosed. A conditional read and invalidate request may be sent via an interconnection network from a first processor that requires exclusive access to a cache block to a second processor that requires exclusive access to the cache block. Data associated with the cache block may be sent from the second processor to the first processor in response to the conditional read and invalidate request and a determination that the cache block is associated with a state of a cache coherency protocol.

### FIELD OF THE INVENTION

The present invention relates generally to coherent multiprocessor systems and, more particularly, to systems and techniques employed to maintain data coherency.

### DESCRIPTION OF THE RELATED ART

Maintaining memory coherency among devices or agents (e.g., the individual processors) within a multiprocessor system is a crucial aspect of multiprocessor system design. Each of the agents within the coherency domain of a multiprocessor system typically maintains one or more private or internal caches that include one or more cache blocks or lines corresponding to portions of system memory. As a result, a cache coherency protocol is needed to control the conveyance of data between these internal caches and system memory. In general, cache coherency protocols prevent multiple caching agents from simultaneously modifying respective cache blocks or lines corresponding to the same system memory to have different or inconsistent data.

Hardware-based cache coherency protocols are commonly used with multiprocessor systems. Hardware-based cache coherency protocols typically enable the cache controllers within the processors of a multiprocessor system to snoop or watch the communications occurring via an interconnection network (e.g., a shared bus) that communicatively links the processors. Additionally, hardware-based cache coherency protocols typically enable the cache controllers to establish one of a plurality of different cache states for each cache block associated with the processors or other caching agents. Three hardware-based cache coherency protocols are commonly known by the acronyms that represent the cache states which are possible under each of the protocols. Namely, MSI, MESI and MOESI, in which the letter “M” represents a modified state, the letter “S” represents a shared state, the letter “E” represents an exclusive state, the letter “O” represents an owned state and the letter “I” represents an invalid state.

When one of the processors or agents within a multiprocessor system needs to modify one of its cache lines or blocks, that processor or agent must typically obtain exclusive ownership of the cache block to be modified. Typically, the agent attempting to gain exclusive ownership or control of a cache block generates an invalidate command on the interconnection network that communicatively links the agents. Other agents that also have a copy of that cache block, but which are not attempting to modify the cache block, will invalidate their copy of the cache block in response to the invalidate command or request, thereby enabling the requesting agent to obtain exclusive control over the cache block.

Hardware-based cache coherency protocols usually enable multiple agents or processors to hold a cache block in a shared state. Each of the agents holding a particular cache block in a shared state has a current (i.e., non-stale) copy of the data in the system memory corresponding to that shared cache block. Thus, it is possible that two or more agents (each of which holds a particular cache block in a shared state) may attempt to modify that particular cache block (i.e., store different values in their respective copy of the cache block) approximately simultaneously. As a result, a first agent attempting to modify the cache block may receive an invalidate request from a second agent, which is also attempting to modify the cache block, at about the same time the first agent issues its invalidate request.

One manner of managing approximately simultaneous invalidation requests for the same cache block is to promote one of the invalidation requests on-the-fly to a read and invalidate request. As is well known, a read and invalidate request results in the transfer of requested data (i.e., a read) from one processor cache to another processor cache and the subsequent invalidation of the cache block from which the data was transferred (i.e., read). Unfortunately, on-the-fly promotion is technically very difficult to accomplish because the communication latency introduced by the interconnection network may prevent the agent that issues the second invalidation request from learning about the first issued invalidation request early enough to effectively promote the second invalidation request to a read and invalidate.

Another approach that eliminates the timing difficulties associated with on-the-fly promotion of an invalidate request is to issue a read and invalidate request regardless of the state of the local cache (i.e., do not use invalidate requests). While such an approach eliminates the timing difficulties associated with on-the-fly promotion, this approach may result in unnecessary data transfers (i.e., increased traffic on the interconnection network) because cache data is transferred to the requesting agent or processor even if the local cache block associated with that agent or processor is in a shared state (i.e., even if the local cache block already holds current data).

### BRIEF DESCRIPTION OF THE DRAWINGS

FIG. 1 is a block diagram of an example of a multiprocessor system;

FIG. 2 is a flow diagram that depicts by way of an example one manner in which the processors within the multiprocessor system shown in FIG. 1 generate conditional read and invalidate requests;

FIG. 3 is a flow diagram that depicts by way of an example one manner in which the processors within the multiprocessor system shown in FIG. 1 process conditional read and invalidate requests; and

FIGS. 4a-4d are block diagrams depicting by way of an example the stages through which the multiprocessor system shown in FIG. 1 may progress when using the conditional read and invalidate request generation and processing techniques shown in FIGS. 2 and 3.

### DESCRIPTION

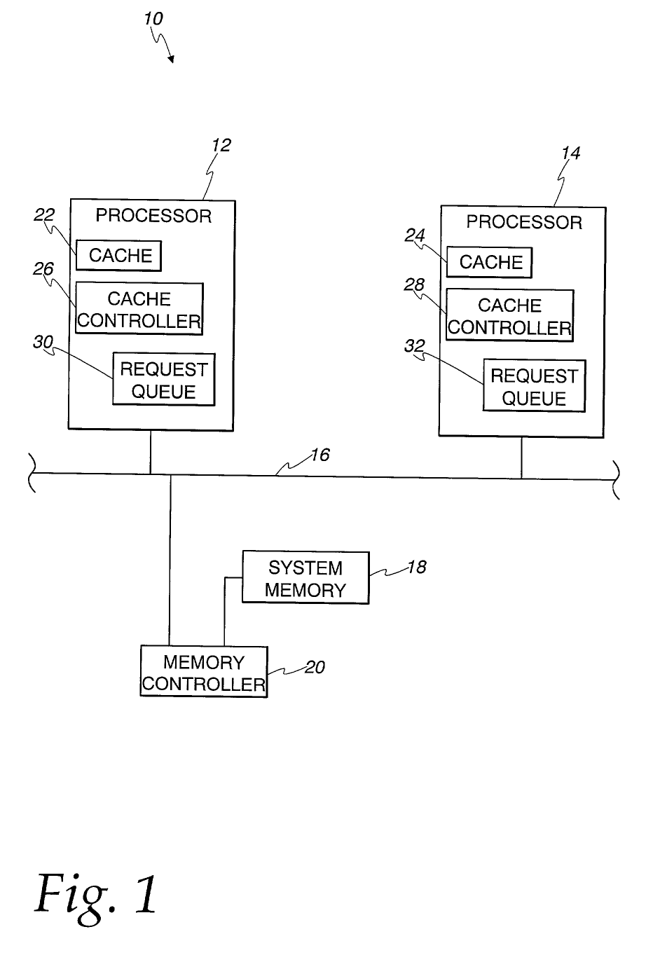

FIG. 1 is a block diagram of an example of a multiprocessor system 10. As shown in FIG. 1, the multiprocessor system 10 includes a plurality of processors 12 and 14 that are communicatively coupled via an interconnection network 16. The processors 12 and 14 are implemented using any desired processing unit such as, for example, Intel Pentium™ processors, Intel Itanium™ processors and/or Intel Xscale™ processors.

The interconnection network 16 is implemented using any suitable shared bus or other communication network or interface that permits multiple processors to communicate with each other and, if desired, with other system agents such as, for example, memory controllers. Further, while the interconnection network 16 is preferably implemented using a hardwired communication medium, other communication media, including wireless media, could be used instead.

As depicted in FIG. 1, the multiprocessor system 10 also includes a system memory 18 communicatively coupled to a memory controller 20, which is communicatively coupled to the processors 12 and 14 via the interconnection network 16. Additionally, the processors 12 and 14 respectively include caches 22 and 24, cache controllers 26 and 28 and request queues 30 and 32.

As is well known, the caches 22 and 24 are temporary memory spaces that are private or local to the respective processors 12 and 14 and, thus, permit rapid access to data needed by the processors 12 and 14. The caches 22 and 24 include one or more cache lines or blocks that contain data from one or more portions of (or locations within) the system memory 18. As is the case with many multiprocessor systems, the caches 22 and 24 may each contain one or more cache lines or blocks that correspond to the same portion or portions of the system memory 18. For example, the caches 22 and 24 may contain respective cache blocks that correspond to the same portion of the system memory 18. Although each of the processors 12 and 14 is depicted in FIG. 1 as having a single cache structure, each of the processors 12 and 14 could, if desired, have multiple cache structures. Further, the caches 22 and 24 are implemented using any desired type of memory such as, for example, static random access memory (SRAM), dynamic random access memory (DRAM), etc.

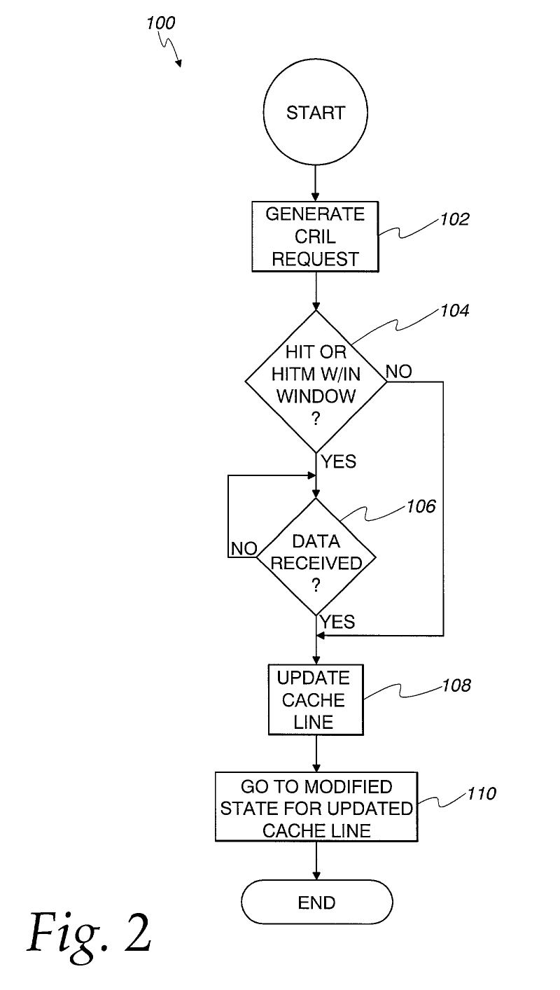

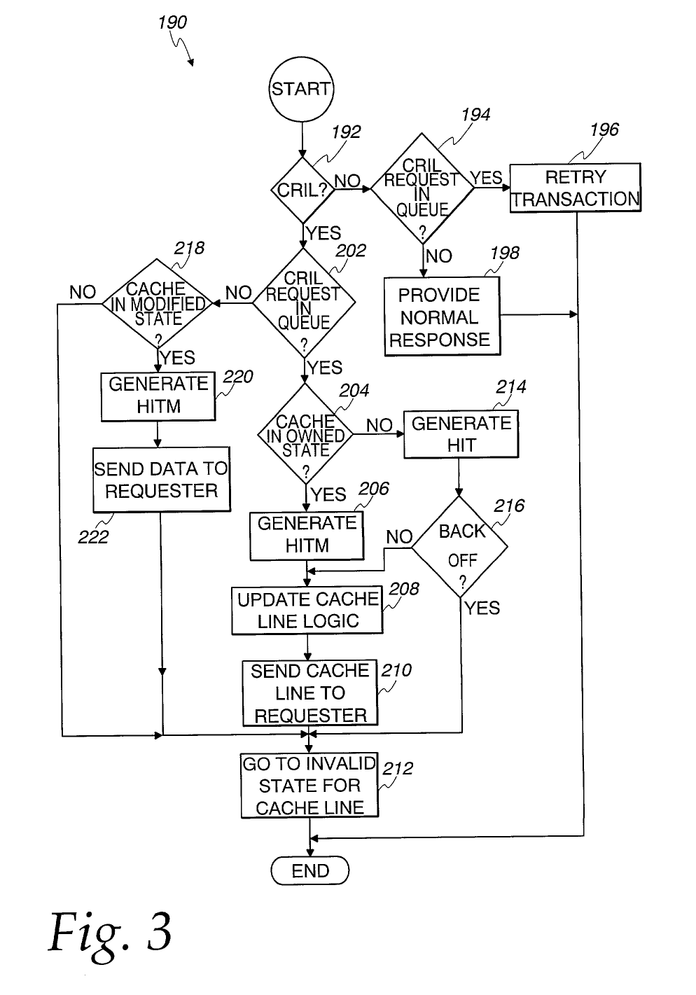

In general, the cache controllers 26 and 28 perform functions that manage updates to the data within the caches 22 and 24 and manage the flow of data between the caches 22 and 24 to maintain coherency of the system memory 18 corresponding to the cache blocks within the caches 22 and 24. More specifically, the cache controllers 26 and 28 perform updates to cache lines or blocks within the respective caches 22 and 24 and change the status of these updated cache lines or blocks within the caches 22 and 24 as needed to maintain memory coherency or consistency. The processors 12 and 14 and, in particular, the cache controllers 26 and 28, may employ any desired cache coherency scheme, but preferably employ a hardware-based cache coherency scheme or protocol such as, for example, one of the MSI, MESI and MOESI cache coherency protocols. As described in greater detail below in connection with FIGS. 2 and 3, the cache controllers 26 and 28 are configured or adapted to minimize data traffic associated with data transfers between the caches 22 and 24 over the interconnection network 16. Specifically, the cache controllers 26 and 28 are configured or adapted to generate and process conditional read and invalidate requests (CRILs), which eliminate the unnecessary data transfers that typically occur when using the read and invalidate requests commonly used with many hardware-based cache coherency protocols. As is well known, a read and invalidate request always results in the transfer of data between caches via an interconnection network, regardless of whether such a data transfer is necessary. For example, in some multiprocessor systems, a processor that wants to modify a cache block within its local cache is forced to issue a read and invalidate request to obtain a clean or current copy of the cache block data from another processor cache (or system memory) even if the cache block in the local cache is in a shared state (which indicates that the local cache already holds a clean or current copy of the cache block) and even if the other processor is not currently attempting gain control of the cache block to modify the cache block to carry out a store operation or the like.

A CRIL request, on the other hand, generates data transfers between caches only under certain conditions that are associated with the need to actually transfer data to maintain memory coherency. Specifically, a CRIL request results in the transfer of data between caches if (a) two processors are attempting to gain exclusive control of a particular cache block and if the one of the two processors that first receives a CRIL request holds that cache block in an owned state or a shared state, or (b) the processor issuing a CRIL request is attempting to gain exclusive control of the particular cache block and a second processor holds that particular cache block in a modified state and is not currently attempting to gain control of the cache block. In all other instances, a CRIL request will not result in the transfer of data between caches.

While the system memory 18 and the memory controller 20 are illustrated as two discrete blocks in FIG. 1, persons of ordinary skill in the art will recognize that the system memory 18 and the functions performed by the memory controller 20 may be distributed among multiple blocks that communicate with one another via the interconnection network 16 or via some other communication link or links within the multiprocessor system 10. Additionally, while only two processors (i.e., the processors 12 and 14) are shown in the example in FIG. 1, persons of ordinary skill in the art will recognize that the multiprocessor system 10 may include additional processors or agents that are also communicatively coupled via the interconnection network 16, if desired.

FIG. 2 is a flow diagram 100 that depicts, by way of an example, a manner in which the processors 12 and 14 within the multiprocessor system 10 shown in FIG. 1 may generate conditional read and invalidate requests. At block 102, one of the processors 12 and 14 such as, for example, the processor 14, generates a conditional read and invalidate (CRIL) request or command for a particular cache block or line within its cache 24. A CRIL request is generated by the processor 14 when the processor 14 is attempting to carry out a store (or a partial store operation) that affects a cache line or block within its cache 24. The CRIL request or command is broadcast or otherwise communicated or distributed to all of the agents (e.g., the processor 12, the memory controller 20, etc.) within the multiprocessor system 10 via the interconnection network 16. As is well known, the agents within a multiprocessor system, such as the system 10 shown in FIG. 1, may be adapted to snoop or monitor the interconnection network (e.g., the interconnection network 16) to recognize commands or requests such as, for example, a CRIL request.

At block 104, the processor 14 determines whether a hit (HIT) or hit modified (HITM) signal has been asserted on the interconnection network 16 within a predetermined window of time. For example, the predetermined window of time may be about two processor clock cycles. Of course, any other number of clock cycles may be used instead. HIT and HITM signals are generally well known, particularly in connection with microprocessors manufactured by Intel Corporation including, for example, the Intel Pentium™, Intel Itanium™ and Intel Xscale™ families of processors. As discussed in greater detail in connection with FIG. 3 below, a HIT signal will be asserted by another processor, such as the processor 12, if that other processor holds a current (i.e., non-stale) copy of the particular cache line or block being modified by processor 14 in a shared state and if that other processor (e.g., the processor 12) is also attempting to gain exclusive control of the particular cache block over which the processor 14 wants exclusive control (i.e., the processor 12 also has a pending CRIL request). Similarly, a HITM signal will be asserted by the processor 12 if the processor 12 holds a current copy of the particular cache block being modified by the processor 14 in an owned state and if the processor 12 is also attempting to gain exclusive control of the particular cache block to modify the cache block. Still further, a HITM signal will also be asserted by the processor 12 if the processor 12 holds a current copy of the particular cache block being modified by the processor 14 in a modified state.

If a HIT or HITM signal is asserted or present on the interconnection network 16 within the predetermined time window (block 104) then, at block 106, the processor 14 determines whether it has received data (e.g., from the processor 12) associated with the particular cache block over which it needs exclusive control. If the processor 14 determines that no data has been received (block 106), the processor 14 continues to wait for data (block 106). Any data received may be in the form of a partially or completely modified cache line or block (i.e., the data within the cache block has been completely or partially modified). As discussed in greater detail in connection with FIG. 3 below, if the processor 12 generates a HIT or HITM signal, the processor 12 modifies the cache block (e.g., by carrying out a store operation) prior to sending the cache block data to the processor 14. Further, in some cases, if the processor 12 generates a HIT or HITM signal, it may only perform a partial store operation (i.e., may modify less than all the data within a particular cache block) prior to sending the cache block data to the processor 14.

On the other hand, if the processor 14 determines at block 106 that updated cache data has been received (e.g., from the processor 12), then the processor 14 updates the received cache block within the cache 24 with its own data. The cache block update performed by the processor 14 at block 108 may also involve only a partial store (i.e., a partial data modification) operation. Thus, as can be recognized from FIG. 2, in a situation where two processors are attempting to gain exclusive control of the same cache block to update or to modify different portions of that cache block, the techniques described herein enable one processor to perform its update and then send the updated cache block data to a second processor, which subsequently makes its update to the already modified cache block data. At block 110, the processor 14 sets the state for the updated cache line or block within its cache 24 to a modified state, which indicates to all other agents (e.g., the processor 12, the memory controller 20, etc.) within the multiprocessor system 10 that the most current version of that cache block resides within the cache 24 of the processor 14.

FIG. 3 is a flow diagram 190 that depicts, by way of an example, a manner in which the processors 12 and 14 within the multiprocessor system 10 shown in FIG. 1 process received conditional read and invalidate (CRIL) requests. At block 192, when a processor (which in this example is the processor 12) within the multiprocessor system 10 receives a request from another processor (which in this example is the processor 14), the processor 12 determines whether the request is a CRIL request. If the request is not a CRIL request, the processor 12 determines at block 194 whether it already has a CRIL request in its request queue 30. If the processor 12 determines that it already has a CRIL request in its queue 30, then at block 196 the processor 12 allows a retry of the transaction. On the other hand, if the processor 12 determines at block 194 that it does not already have a CRIL request in its queue 30, then at block 198, the processor 12 provides a normal (or conventional) response to the non-CRIL request.

If the processor 12 determines at block 192 that it has received a CRIL request, then at block 202 the processor 12 determines whether it also holds in its request queue 30 a CRIL request to the same cache line or block associated with the CRIL request received from the processor 14. If a CRIL request to the same cache block is found in the request queue 30 (block 202), then the processor 12 determines whether the cache block associated with the CRIL request is in an owned state at block 204. If the cache block is in an owned state at block 204, then the processor 12 generates a HITM signal on the interconnection network 16 (block 206).

At block 208, the processor 12 updates the cache block logic within its cache 22 and, at block 210, the processor 12 sends the cache block data to the processor 14 via the interconnection network 16. It should be recognized that at block 208 the processor 12 does not actually write new or update data to its cache block but, instead, updates logic within the cache controller 26 to indicate that the processor 12 has completed its response to the CRIL request. In this manner, the processor 12 can reduce overall power consumption by eliminating a write to physical memory. Of course, if desired, the process 12 could be configured to actually update its cache 22 at block 208. At block 212, the processor 12 sets the state of the cache block within its cache 22 to invalid, thereby indicating to the other processors or agents (e.g., the processor 14, the memory controller 20, etc.) within the multiprocessor system 10 that the cache line or block within the cache 22 contains stale data.

If, at block 204, the processor 12 determines that the cache line or block associated with the CRIL request is not in an owned state, then the processor 12 assumes that the cache line or block is in a shared state and generates a HIT signal on the interconnection network 16 at block 214. At block 216, the processor 12 determines whether any other agents or processors within the system 10 have issued a “back off” request. A “back off” request is preferably generated when more than two processors are attempting to gain exclusive control of a particular cache line or block. In this manner, the cache modifications or updates to be performed by processors that receive a back off request via the interconnection network 16 can be held in abeyance until a cache modification or update currently being performed is completed. In particular, if a processor receives a back off request in connection with a particular cache block, the processor invalidates its copy of that cache block and subsequently issues its CRIL request for that cache block. The updated data for that cache block may then be provided by another processor (which has previously executed its CRIL request) that currently holds the cache block in a modified state. If the processor 12 does not receive a back off request (block 216), then the processor 12 updates the cache line or block within its cache (block 208), sends the updated cache line or block to the processor 14 (block 210) and sets the state for the updated cache line or block within its cache 22 to invalid (block 212). On the other hand, if the processor 12 determines that a back off request has been received (block 216), then the processor 12 sets the state of the cache line or block within its cache 22 to invalid (block 212).

If, at block 202, the processor 12 determines that it does not have a CRIL request in its request queue 30 for a particular cache block (i.e., the processor 12 is not attempting to modify that cache block) then, the processor 12 determines whether the cache line or block being modified within its cache 22 is in a modified state (block 218). If the cache line or block is in a modified state (block 218), then the processor 12 generates a HITM signal on the interconnection network 16 (block 220). At block 222, the processor 12 sends the cache block data to the processor 14. Then, the processor 12 sets the state of the cache block within its cache 22 to invalid (block 212). On the other hand, if the processor 12 determines at block 218 that the cache block is not in a modified state, then the processor 12 sets the state of the cache block within its cache 22 to invalid (block 212).

In the illustrated example, the processes 100 and 190 depicted by FIGS. 2 and 3 are implemented within the processors of a multiprocessor system by appropriately modifying the cache controllers within the processors. For example, the cache controllers 26 and 28 of the processors 12 and 14 may be designed using any known technique to carry out the processes depicted within FIGS. 2 and 3. Such design techniques are well known and the modifications required to implement the processes 100 and 190 shown in FIGS. 2 and 3 involve routine implementation efforts and, thus, are not described in greater detail herein. However, it should be recognized that the conditional read and invalidate request described herein may be implemented in any other desired manner such as, for example, by modifying other portions of the processors 12 and 14, the memory controller 20, etc.

Additionally, although not shown in FIGS. 2 and 3, if either of the processors 12 and 14 receives a request involving a cache block via the interconnection network 16 that is not a CRIL request and the processor receiving the non-CRIL request has a CRIL request to that same cache block, then the processor may retry the CRIL request. On the other hand, if a processor receives a non-CRIL request and does not have a CRIL request in its request queue, then that processor responds to the non-CRIL request in a normal fashion. For example, if the processor 12 receives an invalidate request for a particular cache block from the processor 14 and if the processor 12 does not have a CRIL request for that particular cache block in its request queue 30, then the processor 12 will respond to the invalidate request in the normal manner by invalidating the particular cache block without carrying out any data transfers or the like. Additionally, it should be noted that the memory controller 20 does not respond to CRIL requests because CRIL requests only involve cache-to-cache data transfers.

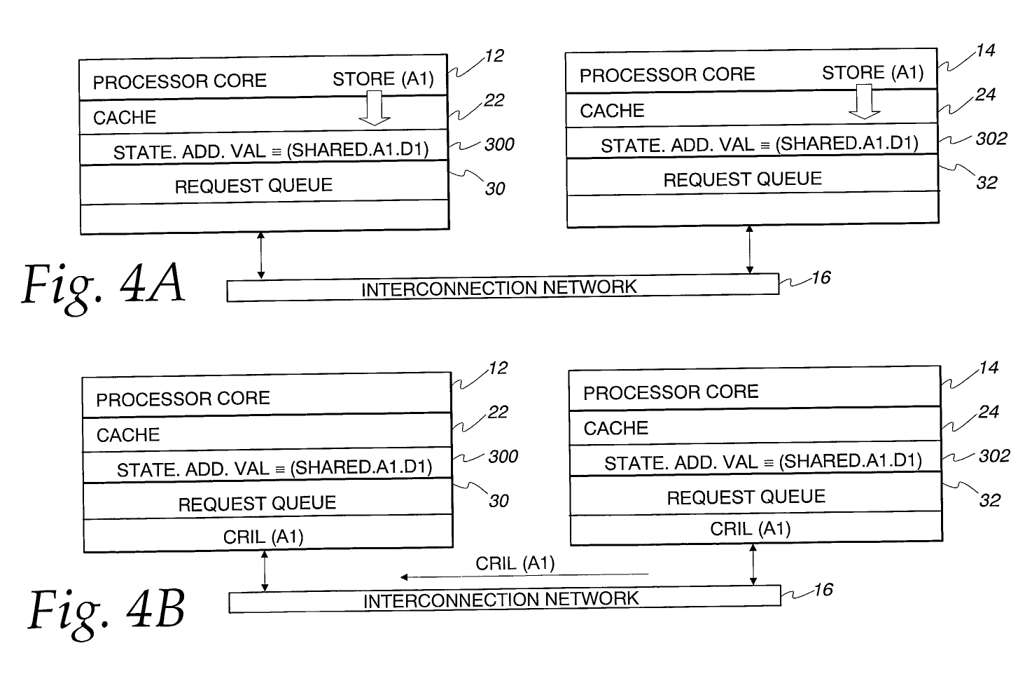

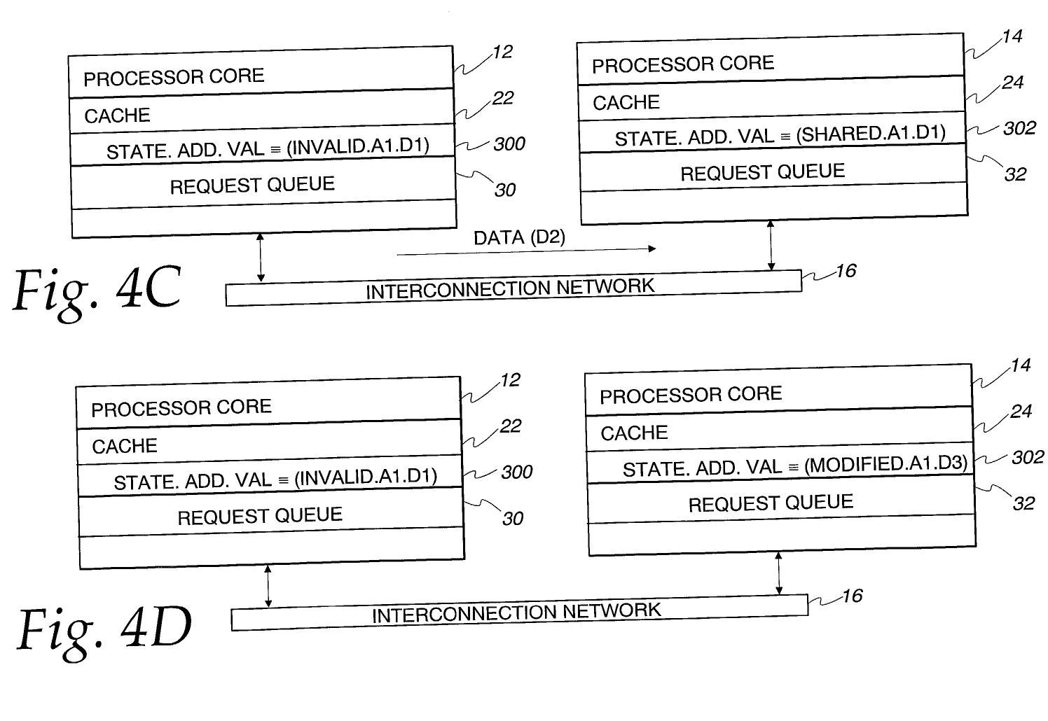

FIGS. 4a-4d are block diagrams depicting, by way of an example, various states through which the multiprocessor system 10 shown in FIG. 1 progresses when using the conditional read and invalidate request generation and processing techniques 100 and 190 illustrated in FIGS. 2 and 3. As shown in FIG. 4a, both of the processors 12 and 14 are about to execute a store operation that affects a cache block associated with the system memory location A1. Both of the processors 12 and 14 initially have data D1 in the cache block that is stored in their respective caches 22 and 24 and which corresponds to the memory location A1. The respective states 300 and 302 of the caches 22 and 24 are shared for the memory location A1 and the data D1 stored therein.

Because both of the processors 12 and 14 are attempting to modify the cache block corresponding to A1, both of the processors 12 and 14 will attempt to gain exclusive control of the cache block corresponding to the memory location A1. Thus, as shown in FIG. 4b, both of the processors 12 and 14 will have CRIL requests for the cache block corresponding to Al in their respective request queues 30 and 32. Both of the processors 12 and 14 generate their CRIL requests according to the technique shown in FIG. 2 and, in particular, generate their CRIL requests at block 102 of the technique 100 shown therein. However, in the example of FIG. 4b, the processor 14 is first to issue its CRIL(A1) request via the interconnection network 16 to the processor 12.

The processor 12 responds to the CRIL(Al) request received from the processor 14 in accordance with the technique 190 shown in FIG. 3. By way of an example, the processor 12 first determines whether it already has a CRIL(A1) request in its request queue 32 (e.g., block 202 of FIG. 3). Because the processor 12 already has a CRIL(A1) request in its request queue 30, the processor 12 then determines whether the cache block associated with the memory location A1 is in an owned state (e.g., block 204 of FIG. 3). Because, in this example, the cache block corresponding to the memory location A1 is in a shared state, the processor 12 generates a HIT signal on the interconnection network 16 (e.g., block 214 of FIG. 3). Additionally, because no other processors have issued a back off command (e.g., block 216 of FIG. 3), the processor 12 updates the cache block logic corresponding to the memory location A1 (e.g., block 208) and, as represented in FIG. 4c, sends the modified cache block data to the processor 14 (e.g., block 210 of FIG. 3) via the interconnection network 16. It should be recognized that to reduce or to minimize processor power consumption, the processor 12 may be configured so that data (e.g., D2) is not actually written to the physical cache 22 (which is to be invalidated) but, instead, only the cache block logic or the control logic within the cache controller 26 is updated to indicate that the cache controller 26 has completed execution of the CRIL request from the processor 14. As is also shown in FIG. 4c, after sending the updated cache block to the processor 14, the processor 12 will set the state of the cache block corresponding to the memory location A1 to invalid (e.g., block 212 of FIG. 3). When the processor 14 receives the cache line or block data (e.g., block 106 of FIG. 2), the processor 14 performs its update to the cache line or block corresponding to the memory location A1 (e.g., block 108 of FIG. 2). As depicted in FIG. 4d, after the processor 14 updates the cache block corresponding to the memory location A1 (to include D3), the processor 14 sets the state of the cache block corresponding to the memory location A1 to a modified state (e.g., block 110 of FIG. 2).

From the foregoing, a person of ordinary skill in the art will appreciate that the illustrated CRIL generation and processing techniques described herein reduce or eliminate unnecessary data transfers between processors within multiprocessor systems that use hardware-based cache coherency protocols such as, for example, MSI, MESI and MOESI relative to conventional read and invalidate techniques. In particular, the CRIL generation and processing techniques described herein cause data to be transferred from the cache of a first processor or agent attempting to gain exclusive access or control over a particular cache line or block to the cache of a second processor or agent only if (a) the second processor or agent is also attempting to gain exclusive control over the particular cache line or block and if the second processor or agent holds the particular cache line or block in a shared or owned state, or (b) if the second processor holds the cache line or block in a modified state and if the second processor is not attempting to gain exclusive control of the cache line or block. In all other cases, no data transfer between processors results from a CRIL operation. Thus, the CRIL generation and processing techniques described herein may be advantageously used within any multiprocessor system that employs a hardware-based cache coherency scheme that includes the use of a shared and/or owned cache line or block state.

Although certain methods and apparatus implemented in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A method of controlling a cache block, comprising:
sending a conditional read and invalidate request from a first agent associated with the cache block to a second agent associated with the cache block; and
transferring data between the first and second agents in response to the conditional read and invalidate request.

2. The method of claim 1, wherein sending the conditional read and invalidate request from the first agent associated with the cache block to the second agent associated with the cache block includes sending the conditional read and invalidate request from a first processor requiring exclusive access to the cache block to a second processor requiring exclusive access to the cache block.

3. The method of claim 1, wherein transferring data between the first and second agents in response to the conditional read and invalidate request includes sending updated cache information from the second agent to the first agent.

4. The method of claim 2, wherein transferring data between the first and second agents in response to the conditional read and invalidate request includes sending updated cache information from the second agent to the first agent.

5. The method of claim 1, further including generating one of a HIT and a HITM signal in response to the conditional read and invalidate request.

6. The method of claim 1, further including setting a state associated with the cache block and the second agent to invalid in response to the conditional read and invalidate request.

7. A method of controlling a cache block for use with a cache coherency protocol, the method comprising:
sending a conditional read and invalidate request via an interconnection network from a first processor that requires exclusive access to the cache block to a second processor that requires exclusive access to the cache block; and
sending data associated with the cache block from the second processor to the first processor in response to (a) the conditional read and invalidate request and (b) a determination that a predefined state of the cache coherency protocol is associated with the cache block in the second processor.

8. The method of claim 7, further including generating one of a HIT and a HITM signal in the second processor in response to the determination that the predefined state of the cache coherency protocol is associated with the cache block in the second processor.

9. The method of claim 7, further including associating an invalid state with the cache block in the second processor after sending the data associated with the cache block in the second from the second processor to the first processor.

10. The method of claim 7, wherein the predefined state is one of a shared state, a modified state and an owned state.

11. The method of claim 7, wherein sending the data associated with the cache block from the second processor to the first processor includes sending an updated version of the cache block data from the second processor to the first processor.

12. The method of claim 7, further including generating a back off request in response to an agent requesting exclusive access to the cache block.

13. A method of controlling data transfers between first and second caches, the method comprising:
generating at a first time a first conditional read and invalidate request in response to a request for exclusive access to a cache block within the first cache;
generating at a second time prior to the first time a second conditional read and invalidate request in response to a request for exclusive access to the cache block within the second cache; and
transferring data from the first cache to the second cache upon reception of the second conditional read and invalidate request by an agent associated with the first cache and a determination by the agent that a state of the cache block within the first cache is one of a shared state, an owned state and a modified state.

14. The method of claim 13, further including generating one of a HIT and a HITM signal in response to the determination by the agent that the state of the cache block within the first cache is one of the shared, owned and modified states.

15. The method of claim 13, further including associating an invalid state with the cache block within the first cache after transferring the data from the first cache to the second cache.

16. The method of claim 13, wherein transferring the data from the first cache to the second cache includes sending an updated version of the cache block data from the first cache to the second cache.

17. The method of claim 13, wherein the first and second times occur substantially simultaneously.

18. A processor for use in a multiprocessor system, the processor comprising:
a cache; and
a cache controller to generate a first conditional read and invalidate request in response to the processor requiring exclusive access to a block within the cache and to send data to another processor in response to (a) reception of a second conditional read and invalidate request from the other processor and (b) a determination that a state of the block within the cache is one of a shared state, an owned state and a modified state.

19. The processor of claim 18, wherein the cache controller generates one of a HIT and a HITM in response to the determination that the state of the block within the cache is one of the shared, owned and modified states.

20. The processor of claim 18, wherein the cache controller associates an invalid state with the cache block after sending the data to the other processor.

21. The processor of claim 18, wherein the cache controller sends an updated version of the cache block data to the other processor.

22. A multiprocessor system, comprising:
a first processor having a first cache and a first cache controller;
a second processor having a second cache and second cache controller, wherein the first and second cache controllers generate respective conditional read and invalidate requests in response to requests for exclusive access to cache blocks within the first and second caches; and
an interconnection network that communicatively couples the first and second processors.

23. The multiprocessor system of claim 22, wherein the first and second cache controllers generate HIT and HITM signals on the interconnection network in response to reception of the conditional read and invalidate requests.

24. The multiprocessor system of claim 22, further including a system memory communicatively coupled to the first and second processors via the interconnection network.

25. The multiprocessor system of claim 24, further including a memory controller coupled to the interconnection network.
